(19) United States
(12) Patent Application Publication
(10) Pub. No.: US 2012/0292965 A1
(43) Pub. Date: Nov. 22, 2012

(54) CHILD CAR SEAT

(75) Inventor: Mark Sedlack, Clinton, OH (US)

(73) Assignee: BABY TREND, INC., Ontario, CA (US)

(21) Appl. No.: 13/474,430

(22) Filed: May 17, 2012

Related U.S. Application Data
(60) Provisional application No. 61/487,768, filed on May 19, 2011.
(60) Provisional application No. 61/587,866, filed on Jan. 18, 2012.
(60) Provisional application No. 61/591,627, filed on Jan. 27, 2012.

(51) Int. Cl. B60N 2/28

(52) U.S. Cl. 297/256.16

(57) ABSTRACT

A child car seat is provided that has a full seat configuration, a collapsed configuration, and a booster seat configuration. In both the full seat configuration and the booster seat configuration, a rotatable mounting member has a surface that provides a seating surface for the child. The rotatable receiving member further selectively receiving pieces of a seat back portion to allow conversion from the booster seat configuration to the full seat configuration.

### PRIORITY

The present application claims priority to U.S. Provisional Application No. 61/487,768 filed May 19, 2011; U.S. Provisional Application No. 61/587,866 filed Jan. 18, 2012; and U.S. Provisional Application No. 61/591,627 filed Jan. 27, 2012; the disclosures of which are incorporated herein by reference. The present application is also being co-filed with applications titled Seat Adjustment Mechanism (Applicant reference BTE-P0005-02) and titled Shoulder Belt Height Adjuster (Applicant reference BTE-P0005-03) the disclosures of which are incorporated herein by reference.

### FIELD

The present disclosure relates to generally to a child car seat, and more particularly to a child car seat that is both compact for transport and convertible from a car seat with a back to a booster style child car seat.

### BACKGROUND AND SUMMARY

Child car seats can often be bulky items that prove difficult and costly to transport. Additionally, as a child grows, differing styles of car seats are appropriate. Accordingly, the present disclosure provides a child car seat that is both compactable for transport and convertible from a style having a back portion to a booster style.

According to an embodiment of the present disclosure, a child car seat is provided including: a base portion; a back portion readily attachable and detachable from the base portion, the back portion including a support extending therefrom; and a mount member hingedly coupled to the base portion and including a seating surface for a child sitting in the base portion, the mount member mounting to the support of the back portion to couple the back portion to the base portion.

According to another embodiment of the present disclosure, a child car seat is provided including: a base portion; and a back portion readily attachable and detachable from the base portion, the back portion having a first position where the back portion assumes an upright position relative to the base portion, the back portion having a second position where the back portion assumes a collapsed position relative to the base portion, the back portion being rotated towards a front of the base portion to move the back portion from the first position to the second position.

According to another embodiment of the present disclosure, a child car seat including: a base portion; and a back portion readily attachable and detachable from the base portion, the back portion having a first position where the back portion assumes an upright position relative to the base portion, the back portion having a second position where the back portion assumes a collapsed position relative to the base portion, the collapsed position having a portion of the back portion overlapping with the base portion in all three dimensions.

According to another embodiment of the present disclosure, a child car seat is provided including a base portion. The base portion having a base housing; at least one rigid extension suitable for coupling the base portion to a passenger seat of a car, the extension slidingly engaging the base housing to allow the extension to slide in and out of the base housing; and at least one lock that selectively prevents the extension from sliding into the base housing.

According to another embodiment of the present disclosure, a child car seat is provided including a base housing; a headrest, and a side pad coupled to the headrest such that adjustment of the headrest causes adjustment of the side pad. Lowering of the headrest causes an increased amount of the side pad to engage a portion of the base housing. Engagement of the side pad with the base housing causes the side pad to alter its lateral position to move laterally inward at the urging of the base housing.

### BRIEF DESCRIPTION OF THE DRAWINGS

The above-mentioned and other features of the disclosure, and the manner of attaining them, will become more apparent and the disclosure itself will be better understood by reference to the following description taken in conjunction with the accompanying drawings, wherein:

FIG. 1a illustrates a child seat with a back portion attached and in a first orientation;

FIG. 1b illustrates the child seat of FIG. 1 being used as a booster seat with a back;

FIG. 2 illustrates the child seat of FIG. 1 with the back portion removed;

FIG. 3 shows the child seat of FIG. 1 with the back portion attached and in a second position; and

FIG. 4 is a side cross-sectional view of the child seat of FIG. 1;

FIGS. 5a&b are side cross-sectional and perspective views of the back portion of FIG. 1, respectively;

FIG. 5c is a plan view of the back portion of FIG. 1;

FIG. 5d is a side cross-sectional view of the back portion of FIG. 1

FIGS. 6a&b is a overhead perspective view of a portion of the child seat in the position of FIG. 3 with the upholstery removed;

FIG. 7 is an overhead perspective view of the child seat in the position of FIG. 1 with various parts removed to show additional detail and with the upholstery removed;

FIG. 8 is a perspective view of a riser apparatus of the child seat of FIG. 1;

FIG. 9a-c are pictures of a belt tether used with the apparatus of FIG. 2;

FIGS. 10a-e are pictures of the child seat of FIG. 1 with a head support portion at multiple settings;

FIGS. 11a-c are pictures of inserts used in the child seat of FIG. 1;

FIGS. 12a-b are perspective views of the base portion of the child seat of FIG. 1;

FIG. 13 is a front bottom perspective view of the base portion of the child seat of FIG. 1;

FIG. 14 is a back bottom perspective view of the base portion of the child seat of FIG. 1;

FIG. 15 is a top perspective view of a lower attachment mechanism of the child seat of FIG. 1 with portions removed;

FIG. 16 is a side perspective view of the lower attachment mechanism of the child seat of FIG. 1 with portions removed;

FIGS. 17a-b are overhead and side plan views of the lower attachment mechanism of the child seat of FIG. 1; and

FIGS. 18a-b are perspective views of the lower attachment mechanism of the child seat of FIG. 1.

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION

The embodiments disclosed herein are not intended to be exhaustive or to limit the disclosure to the precise forms disclosed in the following detailed description. Rather, the embodiments are chosen and described so that others skilled in the art may utilize their teachings.

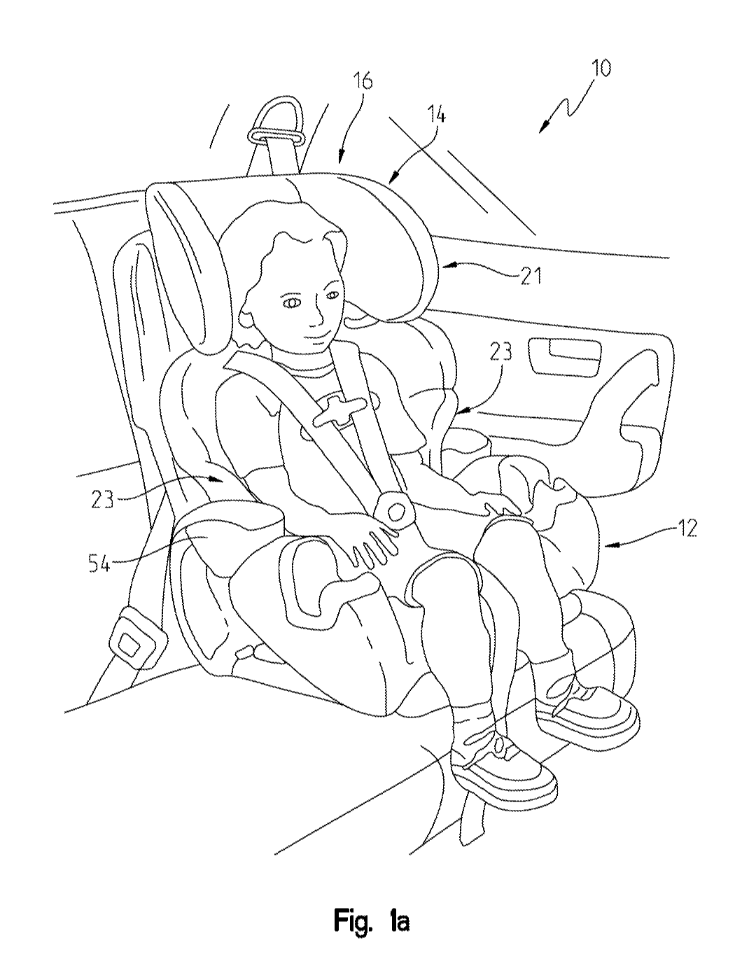

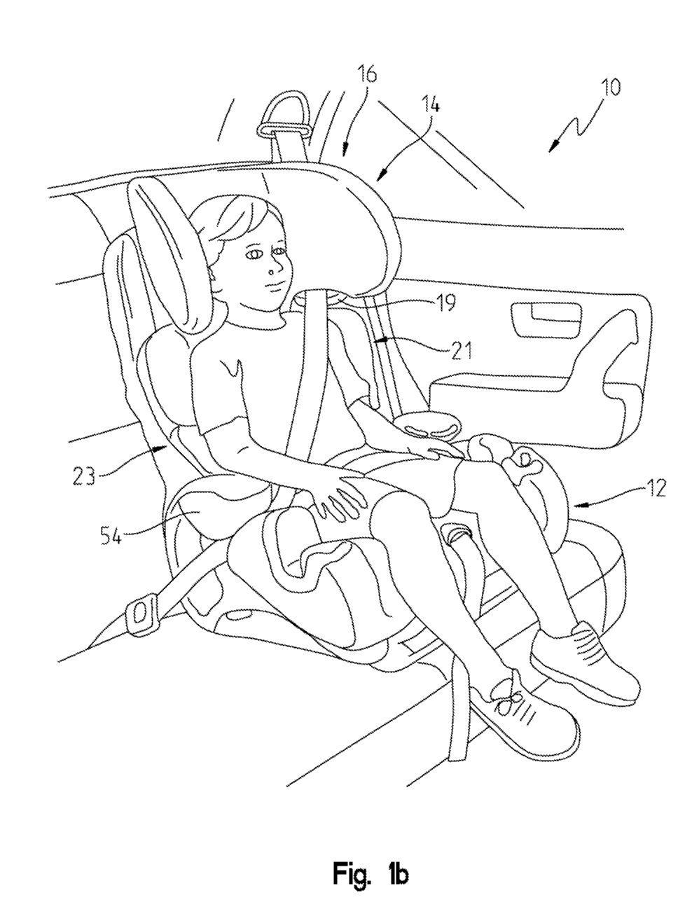

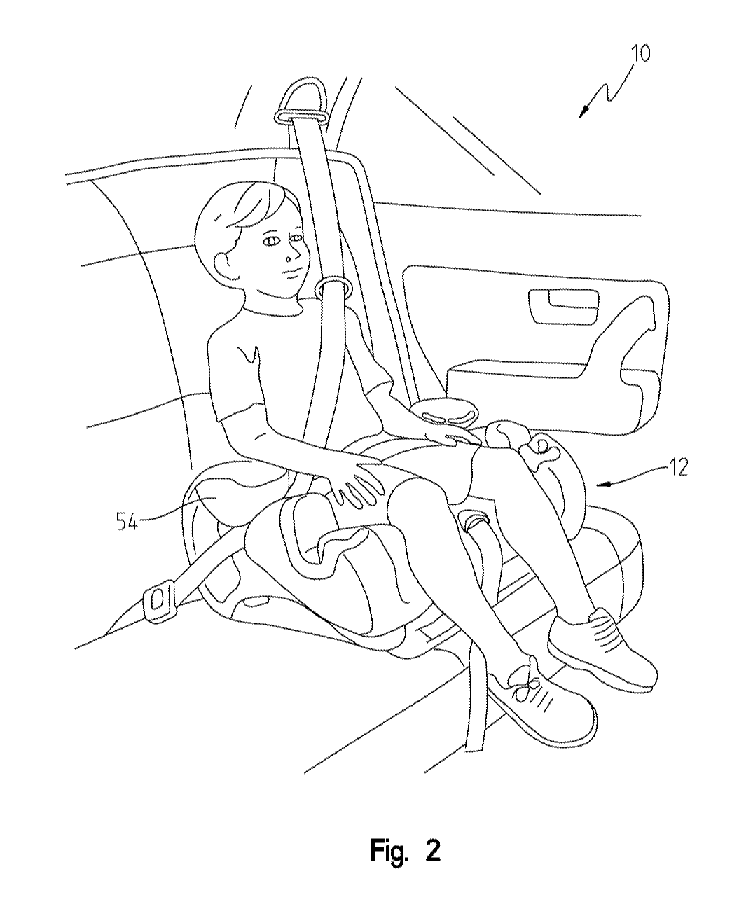

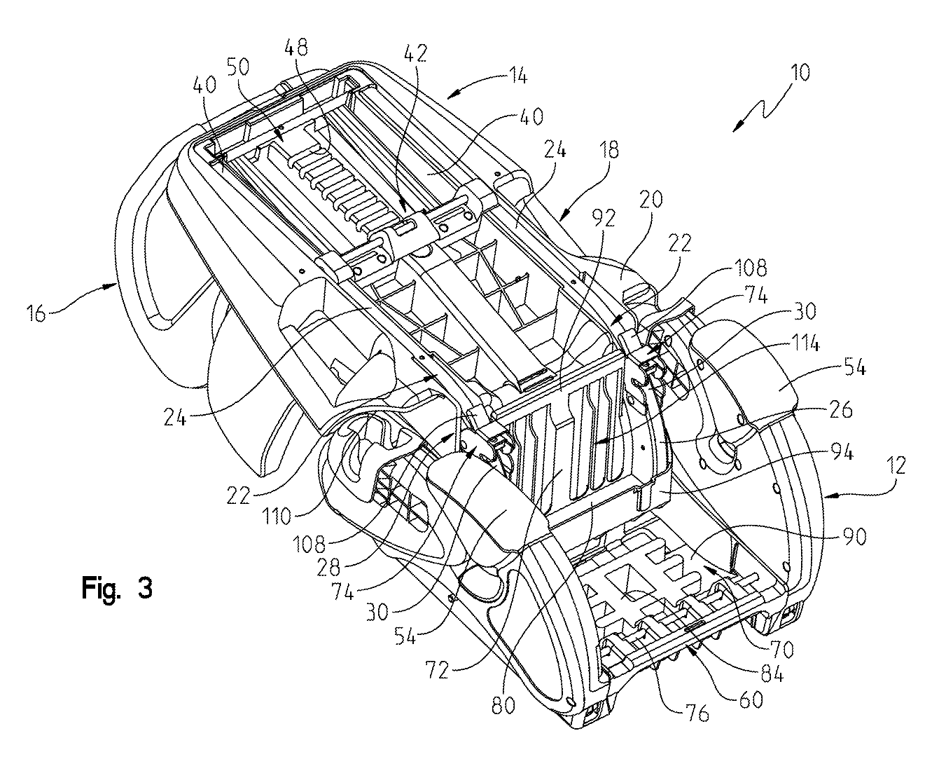

Referring to FIG. 1a, an exemplary child car seat 10 is shown. Car seat 10 generally includes a base portion 12 and a back portion 14. Base portion 12 and back portion 14 are separable. FIG. 2 shows car seat 10 in use where back portion 14 is removed and only base portion 12 is being used. In addition to being separable, base portion 12 and back portion 14 have orientations that are hingedly connected. FIG. 1a shows seat 10 with back portion 14 locked in an upright position. FIG. 3 shows seat 10 with back portion 14 in a lowered position.

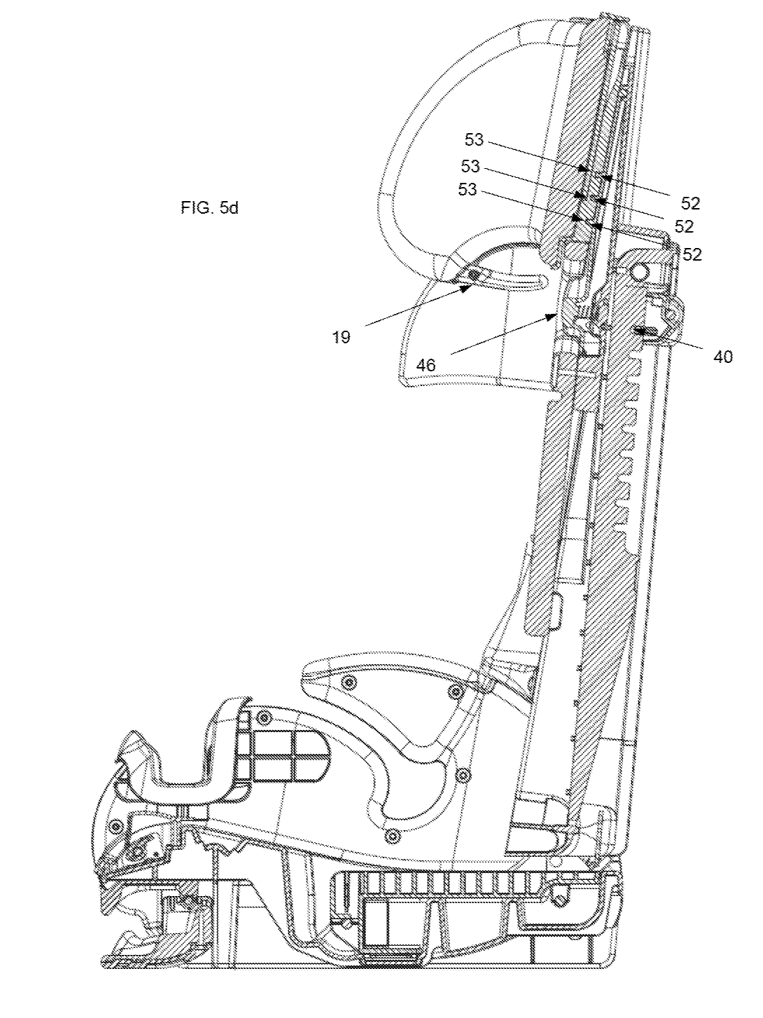

Back portion 14, as shown in FIGS. 5a&b includes head support portion 16 and lumbar support portion 18. Head support portion 16 is adjustable and lockable relative to lumbar support portion 18. Lumbar support portion 18 is further adjustable relative to base portion 12. Head support portion 16 includes an adjustment mechanism 42 (FIGS. 5a&b). Adjustment mechanism 42 includes a lock rod, 40 (FIG. 5d), and a button (actuator) 46 mechanically coupled to lock rod 40.

Button 46 includes a lower portion 47 that engages slides 44 (FIG. 5a). Slides 44 are fixedly coupled to lock rod 40. Button 46 further includes upper portion 49 that includes a front lock projections 52. Front lock projections 52 are sized, shaped, and located to engage lock receivers 53 disposed on the rear of head support portion 16.

Lock rod 40 (FIG. 5d) is moveable through activation of button 46. Lock rod 40 has a first position that corresponds with a first position of button 46, in which lock rod 40 engages one of detents 48 in lock plate 50 of lumbar portion 18.

The first position of button 46 locks the relative positioning of the head support portion 16 and the lumbar support portion 18 relative to each other and vertically relative to base portion 12 by placing lock rod 40 it its first position. The first position of button 46 also places front lock projections 52 within lock receivers 53. A plurality of springs bias button 46 and lock rod 40 to the first position.

Lock rod 40 has a second position that corresponds with a second position of button 46 in which lock rod 40 is disengaged from detents 48 of lock plate 50 and front lock projections 52 disengage from lock receivers 53. The second position allows adjustment of the height of head support portion 16 relative to lumbar support portion 18 and the adjustment of either or both head support portion 16 and lumbar support portion 18 relative to base portion 12. Movement of button 46 between the first position and the second position involves pressing button 46 rearward such that it rotates about its upper end.

Harness voids 55 are disposed on either side of button 46 in lumbar support portion 18. As lumbar support portion 18 is adjusted relative to base portion 12, harness voids 55 are also adjusted. Accordingly, the height of harness voids 55 are adjustable without having to remove and re-thread belts.

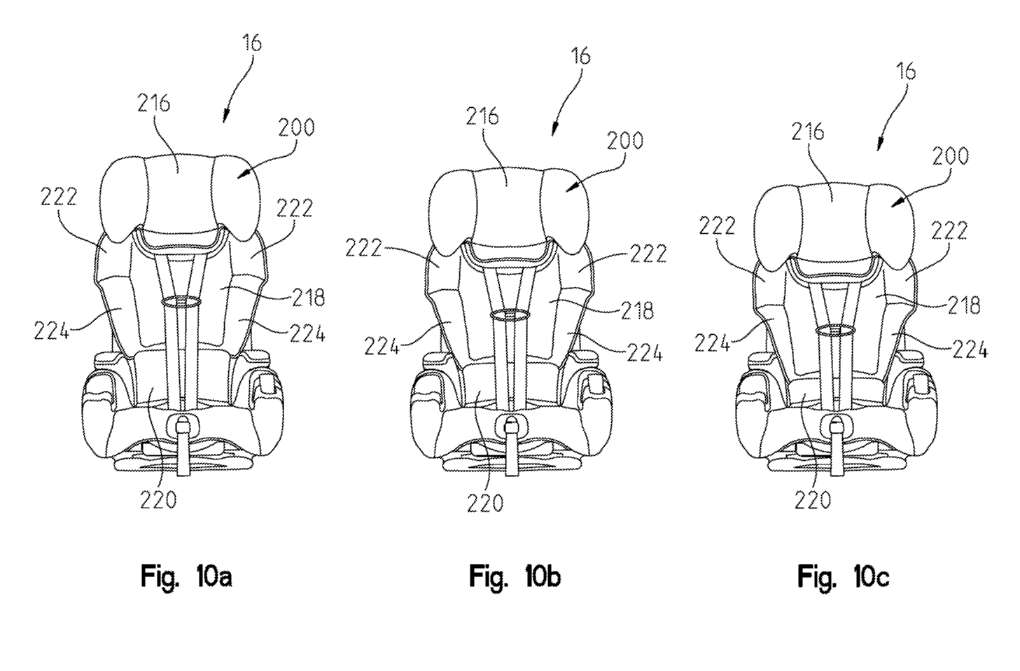

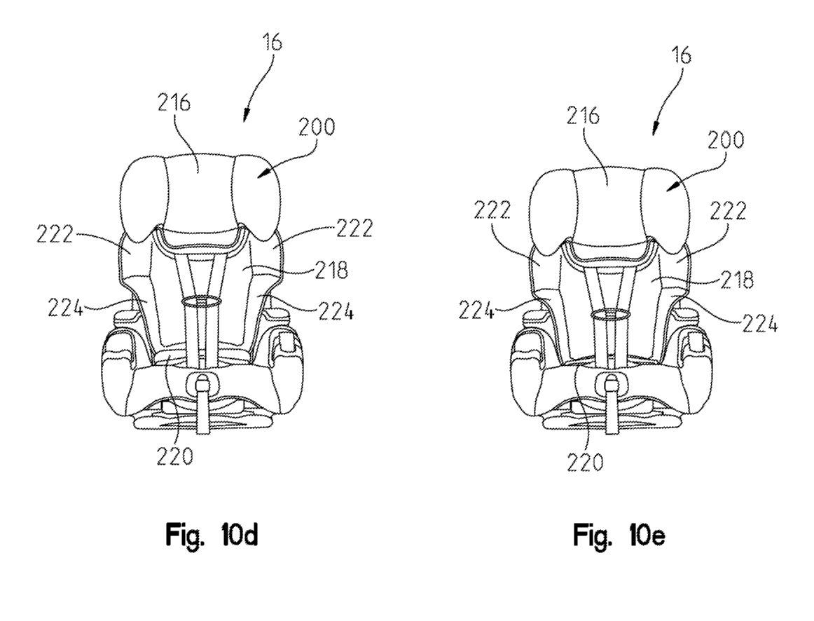

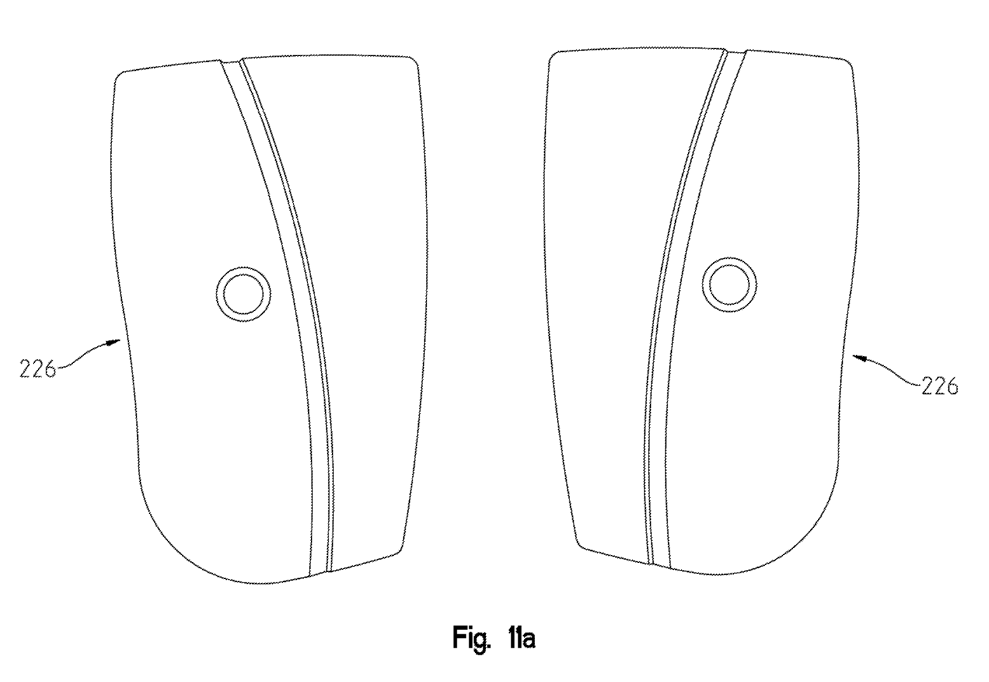

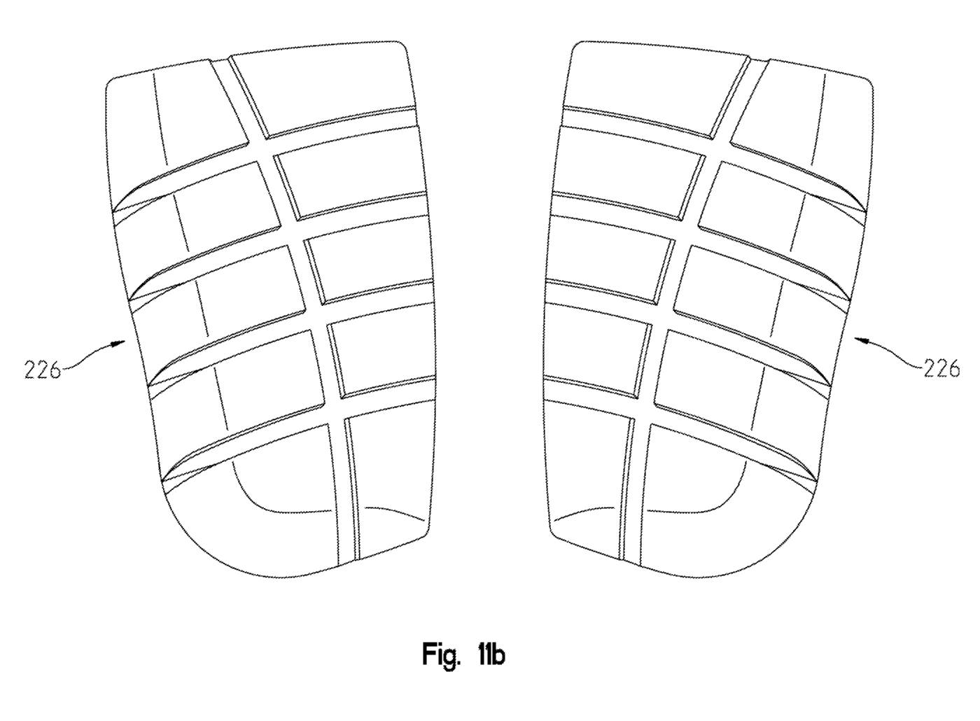

FIGS. 10a-e show head support portion 16 positioned at a plurality of heights. Head support portion 16 includes covering 200. Covering 200 includes head support covering 216 and torso covering 218. As shown by the varying heights in FIGS. 10a-e, both head support covering 216 and torso covering 218 move with head support portion 16.

Torso support covering 218 includes a central portion 220, opposing upper side portions 222, and opposing lower side portions 224. Opposing upper side portions 222 are positioned rearwardly of head support portion 16. Accordingly, any attempt to push side portions 222, 224 inwardly causes upper side portions 222 to abut the rear side of head support portion 16. Once upper side portions 222 are abutting the rear side of head support portion 16, further inward motion imparted to upper side portions 222 causes upper side portions to flex. The flexing is provided as the lower sides of upper side portions 222 do not engage the back side of head support portion 16. The flexing allows buildup of potential energy that urges upper side portions 222 outwardly.

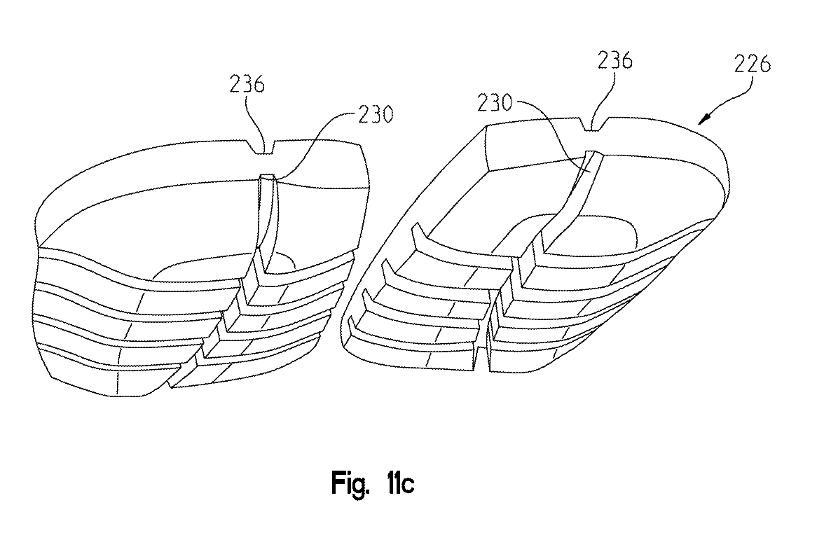

Opposing lower side portions 224 include inner flexible supports 226, FIGS. 11a-c. When head support portion is in the highest position, FIG. 10a, the lower end of opposing lower side portions 224 almost clear armrests 54. Armrests 54 engage the lower ends of opposing lower side portions 224 to keep opposing lower side portions 224 between armrests 54. As head support portion 16 is lowered, greater portions of opposing lower side portions 224 are below the height of armrests 54. Accordingly, as head support portion 16 is lowered, greater portions of opposing lower side portions 224 are urged inwardly.

As previously noted, opposing upper side portions are restricted from moving inward. Lowering head support portion 16 urges opposing lower side portions 224 inward. Opposing upper 222 and lower side portions 224 are formed from a continuous piece of fabric. The opposing forces supplied by head support portion 16 and armrests 54 cause side portions 222, 224 to flex.

Inner flexible supports 226 are sewn into opposing lower side portions 224 and include inner sides 234, FIG. 11a, and outer sides 232, FIG. 11b. Inner flexible supports 226, on outer sides 232, have a plurality of substantially horizontal voids 228 as well as curving generally vertical void 230. Inner sides 234 of inner flexible supports 226 also have curving generally vertical void 236 that mirrors void 230. Inner flexible supports 226 are illustratively made from expanded polypropylene. Expanded polypropylene is flexible, as will be discussed in more detail below. Voids 228, 230, 236 aid in allowing supports 226 to bend and flex when stressed by armrests 54 and head support 16 (via upper side portions 222).

As seen most clearly in FIGS. 10a-e, lowering head support portion 16 also lowers covering 200 includuing head support covering 216 and torso covering 218. As previously noted, a lower positioning of torso covering 218 causes greater position interference with armrests 54. Thus, lower positioning of head support portion 16 provides an increased amount of lower side portions 224 between armrests 54. An increased amount of lower side portions 224 between armrests 54 creates a smaller space between inner surfaces of opposing lower side portions 224. Accordingly, a lower overall height is paired with a decreased width of the seating area. On average, a child for whom a lower height is appropriate would also find that a decreased width of the seating area is also appropriate. Thus, appropriate adjustment of the height of head support portion 16 also provides appropriate adjustment of the width of the seating area.

Lumbar support portion 18 includes lumbar housing 20, fabric covering 21, and a pair of support beams 22. Lumbar housing 20 is primarily constructed of a hard plastic. Fabric covering covers lumbar housing 21 and also includes lateral pockets 23 (FIG. 1). Lateral pockets 23 contain side impact supports. Side impact supports are plastic pieces designed to cushion and protect in the event that later forces are imparted on car seat 10. When lumbar support portion 18 is raised relative to base portion 12 (FIGS. 1b, 5d, 4) a greater portion of lateral pockets are clear of armrests 54. Fabric covering 21 then pulls pockets 23 and side impact supports outward and rearward. When lumbar support portion 18 is lowered relative to base portion 12 (FIGS. 5b, 1) armrests 54 engage more of pockets 23 and urge them inward.

When lumbar support portion 18 is in the raised position, or otherwise, car seat 10 can also serve as a booster seat with a back (FIG. 1b). In such a configuration, the harness belts can be removed and seatbelts from the car can be used. Head support portion 16 further includes belt retainer 19 to aid in this configuration.

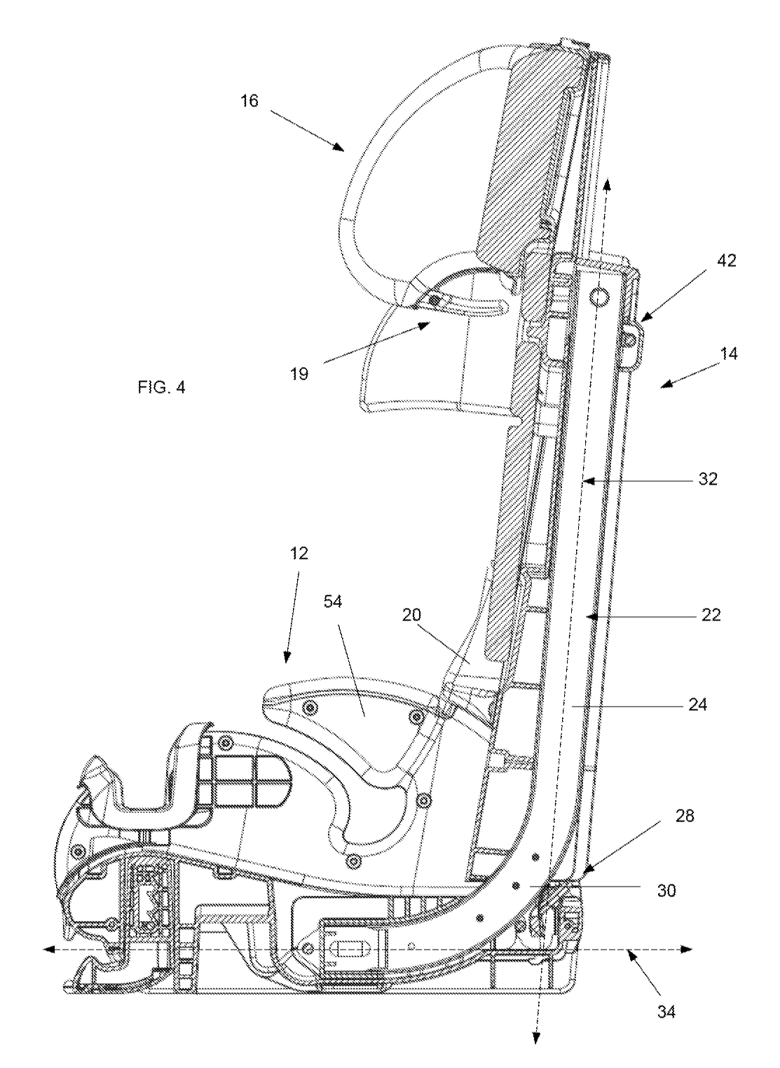

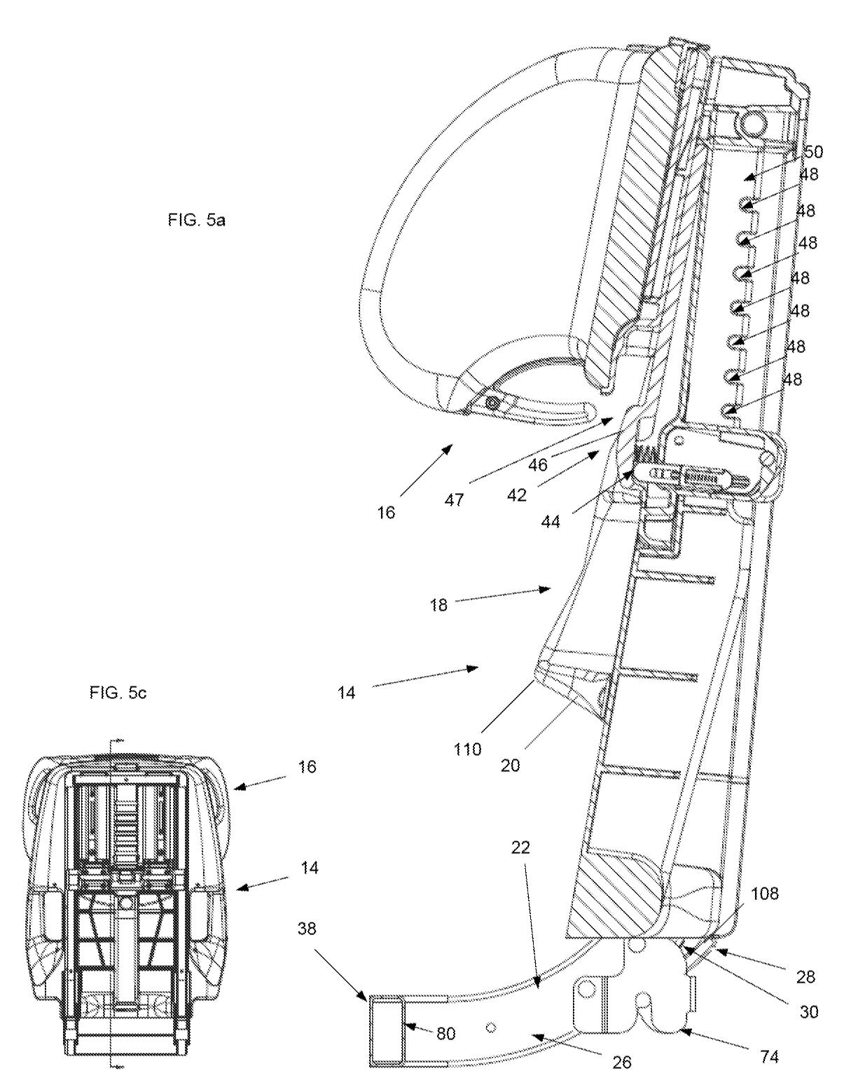

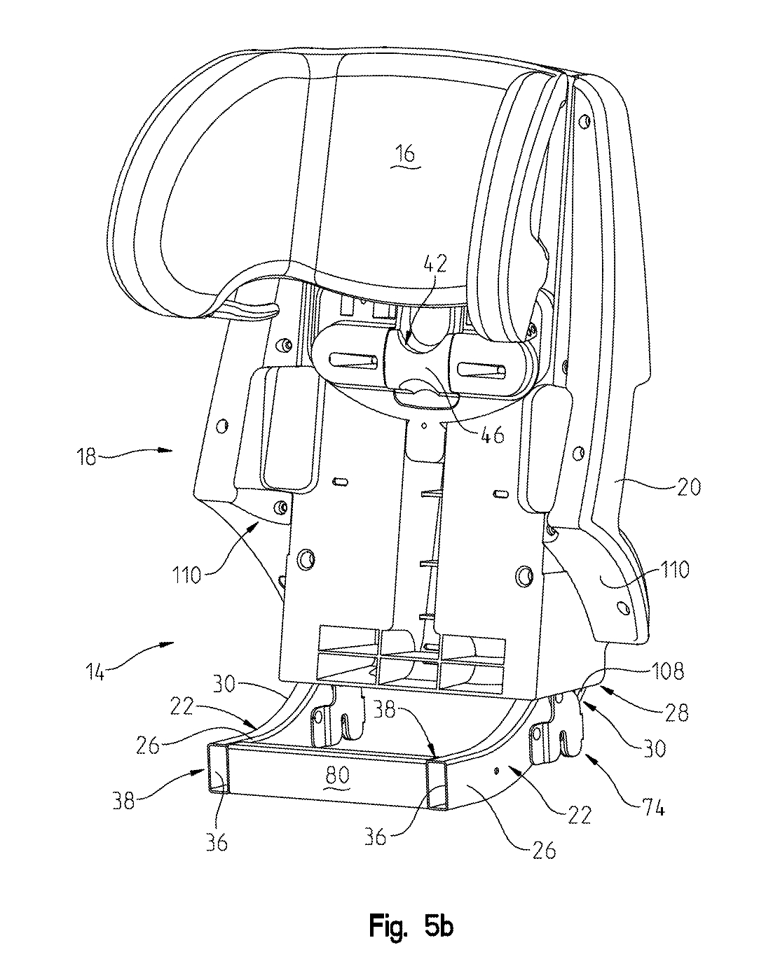

Beams 22 are spaced laterally from each other and assume an “L” shape. Each beam includes a lumbar beam portion 24 fixedly coupled within lumbar housing 20 and a base beam portion 26 that extends out of a lower end 28 of lumbar housing 20. Beams 22 also include an arced portion 30 in between lumbar beam portion 24 and base beam portion 26. Arced portions 30 are curved such that a longitudinal axis 32 of lumbar beam portion 24 is approximately perpendicular to a longitudinal axis 34 of base beam portion 26, FIG. 4. Arced portions 30 have locks 74 attached thereto. Beams 22 are rectangular in cross section and define interior space 36 therein. Base ends 38 of base beam portions 26 are open and sized to receive rotatable connectors 78 of base portion 12 therein. When back portion 14 is attached to base portion 12, rotatable connectors 78 of base portion 12 are each received in interior space 36 of respective base ends 38 of beams 22. Rotatable connectors 78 are sized to snugly fit within interior space 36 of respective base ends 38 of beams 22. Accordingly, when rotatable connectors 78 are within interior space 36 of base ends 38, only pulling base beam portion 26 directly along longitudinal axis 34 of base beam portion 26 allows disengagement of rotatable connectors 78 from base beam portion 26. Additionally, base ends 38 are connected to each other by cross brace 80.

Base portion 12 includes right and left armrests 54 and a seat portion 56 between armrests 54. Seat portion 56 includes front seat portion 58 and rear seat portion 60. Front seat portion 58 includes a top surface 62 that includes a strap aperture 64 and a strap coupler/release (not shown). Strap aperture 64 receives a strap therethrough, that when pulled, tightens seat restraints (not shown). The strap coupler/release receives the strap such that when the strap is pulled, it is prevented from retracting back into base portion 12. A user may depress the strap coupler/release to selectively allow the strap to retract into base portion 12. Strap coupler/release is biased to the position that prevents strap retraction.

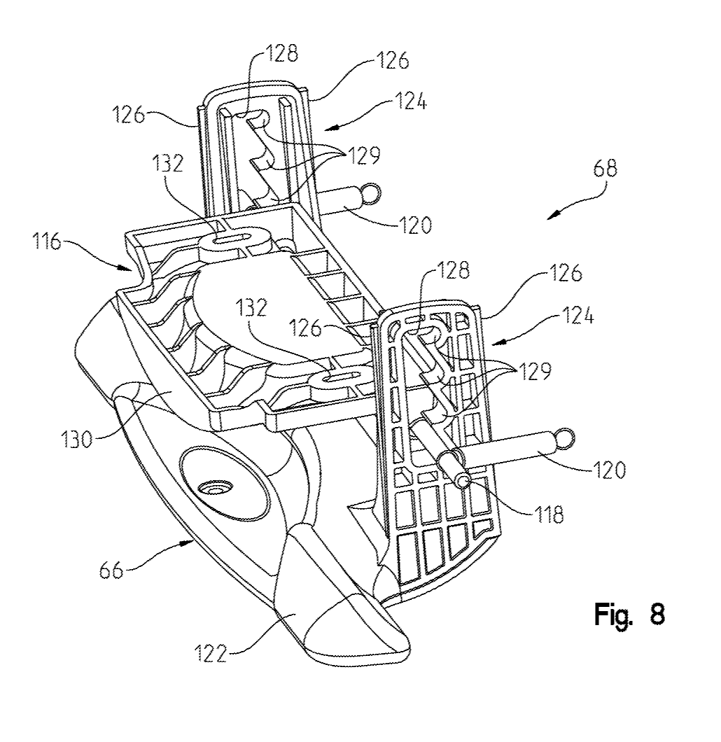

Front seat portion 58 also includes a bottom surface that includes riser apparatus 68. Riser apparatus 68, FIG. 8, includes is a foot 66 that can be extended from below base portion 12 to alter the angle that base portion 12 assumes relative to the surface on which car seat 10 rests. Riser apparatus 68 further includes handle 116, retainer bar 118, and a pair of springs 120. Foot 66 includes seat engaging portion 122 and legs 124. Legs 124 are disposed at the lateral sides of seat engaging portion 122 and extend generally perpendicular thereto. Each leg 124 includes alignment spines 126 on fore and aft surfaces thereof and includes detent void 128. Alignment spines 126 correspond and complement tracks defined in the lower surface of base portion 12 to define a movement track for foot 66 relative to base portion 12. More specifically, spines 126 and the tracks in base portion 12 define a linear movement of foot 66. Each detent void 128 includes four detents 129 sized to receive retainer bar 118 therein. Detents 129 are vertically aligned, which is consistent with the linear movement of foot 66. Springs 120 have one end that engages retainer bar 118 and opposite ends that couple to projections on base portion 12. Springs 120 thereby bias retainer bar 118 to a rearward position. The rearward position of retainer bar 118 fixes the relative position of foot 66 to base portion 12. Handle 116 is coupled to retainer bar 118 such that movement of handle 116 causes movement of retainer bar 118. Handle 116 is slidable relative to base portion 12 by virtue of being coupled to base portion 12 through slots 132. Front edge 130 of handle 116 is graspable by a user. In that handle 116 is fixedly coupled to retainer bar 118 and that springs 120 bias retainer bar 118 rearward, handle 116 is likewise biased rearward. A user can pull front edge 130 to move handle 116 forward. Such forward movement results in forward movement of retainer bar 118 which allows movement of foot 66 relative to base portion 12. When a user releases front edge 130, springs 120, through retainer bar 118, pull handle 116 rearward and cause retainer bar 118 to engage a detent 129. The position of foot 66 relative to base portion 12 is then again fixed.

In addition to allowing extension of foot 66 by activation of handle 116, the rear surface of detent void 128 is angled between detents 129. Accordingly, if a user places one hand on foot 66 and applies an upward force on base portion 12 (or a rearward force on head portion 16) the rear surface of detent void will allow legs 124 to lower and urge retainer bar 118 forward. Once legs 124 are low enough such that retainer bar 118 clears the next higher detent 129, springs 120 pull retainer bar 118 into the next higher detent 129. Thus, foot 66 can be extended by force. However, foot 66 can not be retracted by force due to the shape of detent void 128.

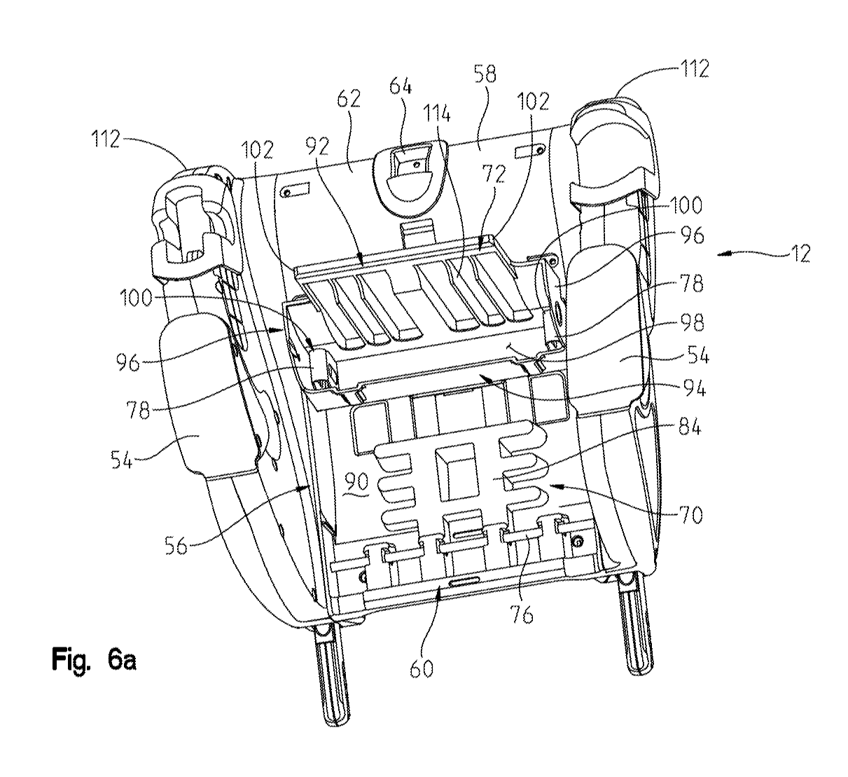

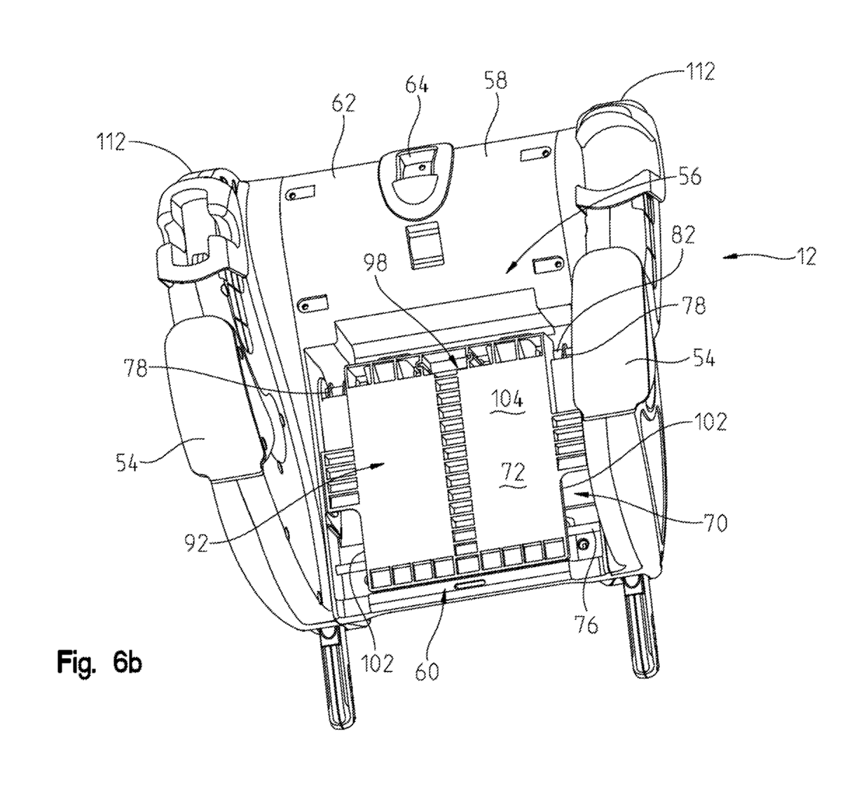

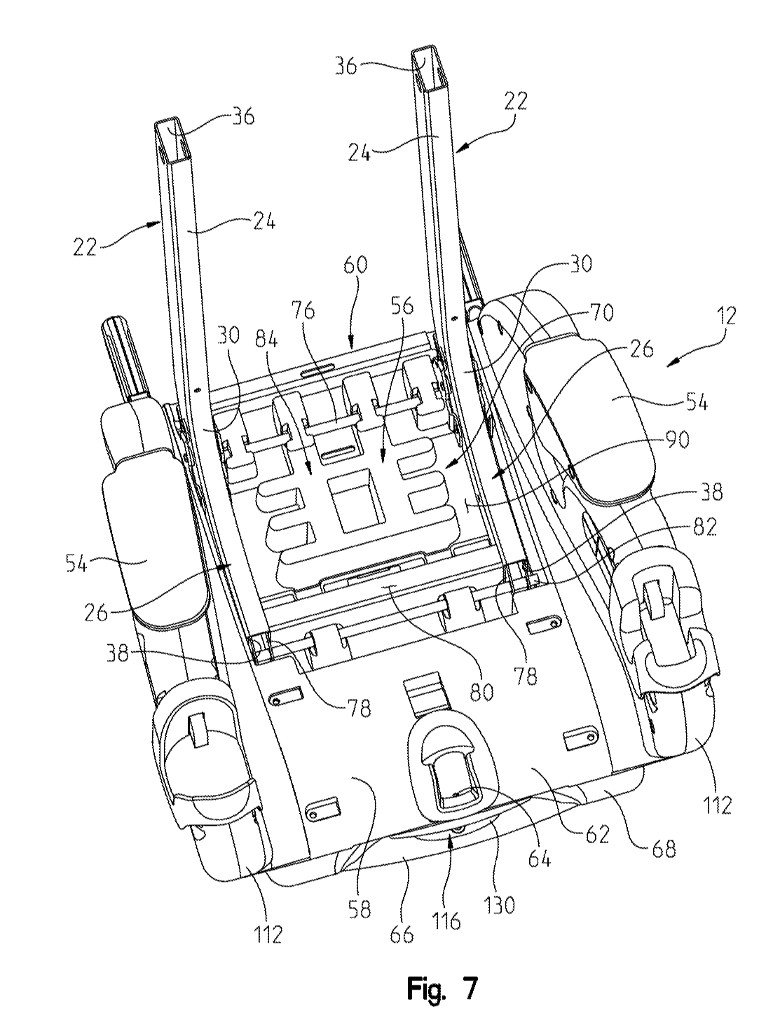

Rear seat portion 60 includes tray 70 and connection support box 72. Tray 70, FIG. 7, extends at a constant width and includes lock bar 76, rotation bar 82, rotatable connectors 78, support grid 84, lock bar mounts 86, and rotation bar mounts 88. FIG. 6a shows rear seat portion 60 with back portion 14 removed and connection support box 72 raised. FIG. 6b shows rear seat portion 60 with back portion 14 removed and connection support box 72 lowered.

FIG. 7 shows base portion 12 with the connection support box 72 removed to show additional detail. It should be appreciated that connection support box 72 is not readily removable. Lock bar mounts 86, rotation bar mounts 88, and support grid 84 are formed up portions that extend upward from floor 90 of tray 70. Lock bar mounts 86 and rotation bar mounts 88 include co-linear apertures therein through which lock bar 76 and rotation bar 82 are received, respectively. Rotatable connectors 78 include apertures therein that receive rotation bar therethrough to allow free rotation of rotatable connectors 78 about rotation bar 82. Rotatable connectors 78 include mount portions 100. Rotatable connectors 78 are coupled to connection support box 72 at the lateral sides of tray 70 such that mount portions 100 extend through rectangular apertures in end wall 98 of connection support box 72. Rotatable connectors 78 are thereby coupled to connection support box 72. Accordingly, connection support box 72 is also freely rotatable about rotation bar 82.

Connection support box 72 includes upper wall 92, lower wall 94, side walls 96, and end wall 98. Upper wall 92 is sized to have the substantially same dimensions as tray 70. However, upper wall 92 includes apertures 102 that accommodate the curving of support beams 22 and locks 74, and does not cover rotation bar mounts 88. Upper wall 92 further includes upper side 104 that, when in a lowered position, provides support to a child seated in seat 10. Upper wall 92 includes lower side 106 that includes ridges 114. When lowered, ridges 114 engage support grid 84 to provide support to upper wall 92 and connection support box 72 generally.

In use, seat 10 is readily convertible between the full seat 10 shown in FIG. 1, the booster seat (base portion 12 only) shown in FIG. 2, and the storage/shipment orientation shown in FIG. 3. To transition from the full seat 10 of FIG. 1, a user first removes the necessary upholstery, if any, to allow access to locks 74 and allow rotation of connection support box 72. A user squeezes on tabs 108 of locks 74 to allow unlocking and disengagement of locks 74 from lock bar 76. Once unlocked, back portion 14 is rotated forward about rotation bar 82. As part of this rotation, support beams 22, rotatable connectors 78, and connection support box 72 all rotate forward about rotation bar 82. Once rotated forward, seat 10 is in the position shown in FIG. 3. In this position, the distance from the bottom of base portion 12 to the height of the back of back portion 14 is smaller than the smallest dimension (height, width, depth) of the seat 10 in the upright position of FIG. 1. Additionally, this position, FIG. 3, provides that the back portion 14 overlaps with the base portion 12 in all three dimensions, thereby allowing for additional compactness. Indeed, both the configurations of FIG. 1 and FIG. 3 provide that the back portion 14 overlaps with the base portion 12 in all three dimensions.

From the position shown in FIG. 3, back portion 14 can be pulled upwardly to disengage support beams 22 from connection support box 72 and rotatable connectors 78. Once back portion 14 is disengaged, connection support box 72 and rotatable connectors 78 can be rotated back down such that the upper surface 104 of upper wall 92 again provides a seating surface. Any desired upholstery is then repositioned or re-attached to arrive at the orientation of seat 10 shown in FIG. 2.

To transition from the seat 10 orientation shown in FIG. 2, appropriate upholstery is pulled back or removed to expose connection support box 72 as shown in FIG. 6b. Connection support box 72 along with rotatable connectors 78 are rotated upward to the position shown in FIG. 6a. Back portion 14 is then lowered onto base portion 12 such that open base ends 38 of support beams 22 engage and receive rotatable connectors 78 therein. Once rotatable connectors 78 are properly seated within base ends 38, back portion 14, connection support box 72, and rotatable connectors 78 are all rotated rearwardly until locks 74 engage and lock with lock bar 76. The engagement of locks 74 with lock bar 76 prevents rotation of support beams 22 about rotation bar 82. Additionally, engagement of locks 74 with lock bar 76 prevents movement of base beam portion 26 along longitudinal axis 34 of base beam portion 26. Disengagement of rotatable connectors 78 from base beam portion 26 is thereby prevented.

In the configurations shown in FIG. 1 and FIG. 2, support grid 84 provides support to lower side 106 of upper wall 92. Thus, support grid 84 allows for clearance and coupling of base portion 12 and support beams 22 while providing a substantially similar support platform to support the child user of seat 10.

Additionally, lower sides of lumbar housing 20 provide an arced surface 110. Arced surface 110 is sized an shaped such that, when in the orientation of FIG. 1, arced surface 110 has clearance relative to armrests 54. Similarly, arced surface 110 is sized and shaped such that, when in the orientation of FIG. 3, arced surface 110 has clearance relative to the armrests 54, more specifically, front portions 112 of armrests 54.

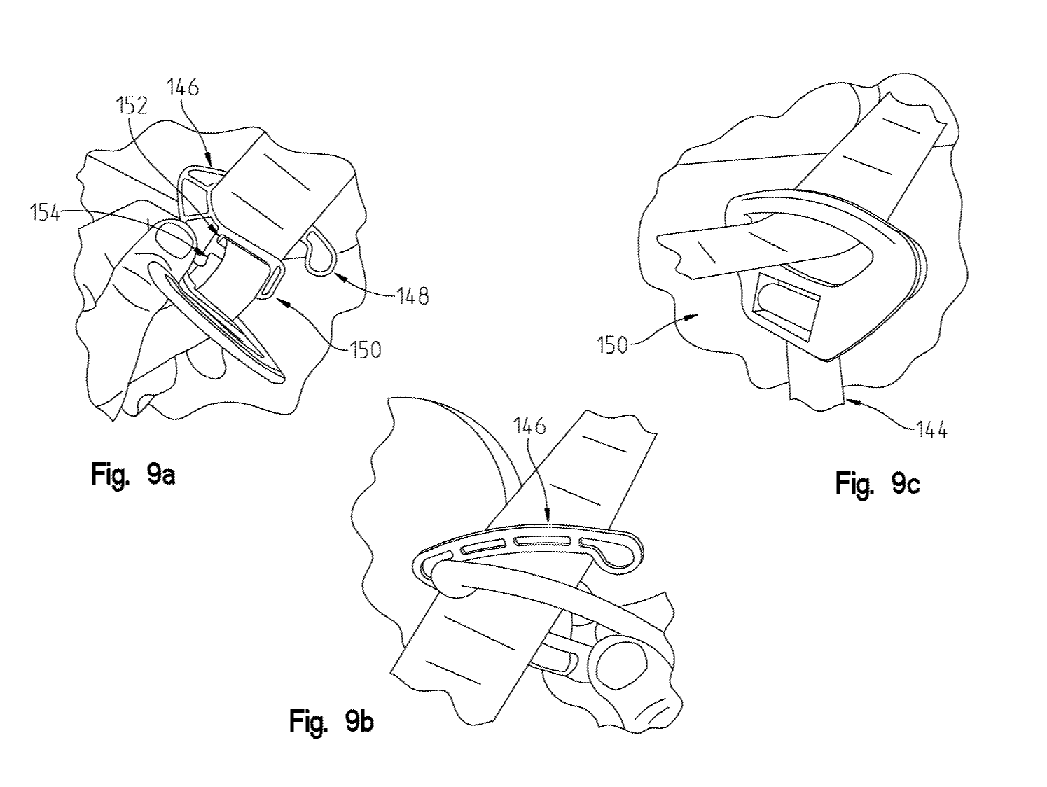

As previously noted, seat 10 can operate as a booster seat (base portion 12 only) shown in FIG. 2. Such operation also includes the use of belt tether 140 (FIG. 9a-c). Belt tether 140 includes elastic (not shown), strap 144, and pair of retainers 146. The elastic couples to the rear of base portion 12. Strap 144 extends between the elastic and retainers 146. Retainers 146 are two identical molded parts. Retainers 146 have open hook portion 148 and slotted adjuster portion 150. One retainer 146 is rotated 180 degrees relative to the other, so open hook portions 148 are facing opposite directions. Retainers 146 are then placed next to the other so that slotted portions 150 line up. Slotted portions 150 include upper slots 152 and lower slots 154. An end of strap 144 is threaded through the upper slots 152 on both retainers 146, then back through lower slots 154 (FIG. 9a). The end of strap 144 is then folded and sewn onto itself to prevent the retainers 146 from detaching.

The geometry of slots 152, 154 serves to act as a sliding bar locking adjuster when load is applied to retainers 146 in a direction outward from the strap. In use, retainers 146 are spread apart and the vehicle shoulder belt is inserted so as to travel though the loop shaped opening formed by both retainers 146 together (FIG. 9b). The upper end of strap 144 is pulled down to adjust and hold the vehicle shoulder-belt in the correct position on the child seated in the base portion 12 (FIGS. 9c, 2).

Base portion 12 of car seat 10 further includes rigid attachment assembly 240. Rigid attachment assembly 240 includes two rigid rods 242 disposed within rod pathways 248 built into base portion 12 and disposed 280 mm apart and conforming to ISO 13216-1. Rigid attachment assembly 240 is used to connect seat 10 to lower anchorages provided proximate the seat bight. In addition to rods 242, assembly 240 includes springs 244, outward locks 246, and inward locks 247.

Rod pathways 248 are rectangular and define pathways in which rods 242 can slide. Rods 242 include body 250, latch end 252, latch release 254, spring interface 256, and slide bolt 258. Latch end 252 is disposed at one end of body 250. Latch end 252 provides a latch that engages a LATCH anchorage system. Latch end 252 is pushed on to the LATCH anchorage system to achieve fixation thereto. Rods 242 are unlatched from the LATCH anchorage system by depressing latch release 254. Spring interface 256 is located at the opposite end of body 250 from latch end 252. Spring interface 256 includes a portion that is secured to body 250 and a portion that is sized and shaped to fit within a cylindrical void of coil springs 244. Slide bolt 258 passes through a bolt void in body 250. Slide bolt 258, in assembly, further passes through slide void 260 of rod pathways 248. Each slide bolt 258 includes bolt head 262 having a diameter greater than a width of slide voids 260. Slide voids 260, with slide bolts 258 define the allowed travel of rods 242 within rod pathways 248.

In operation, rods 242 have a stowed position where springs 244 are compressed and rods 242 are retracted within rod pathways 248 such that latch ends 252 are proximate rod pathways 248. Rods 242 further have an extended position where springs 244 are decompressed and latch ends 252 are extended away from rod pathways 248. Accordingly, springs 244 urge rods 242 to the extended position.

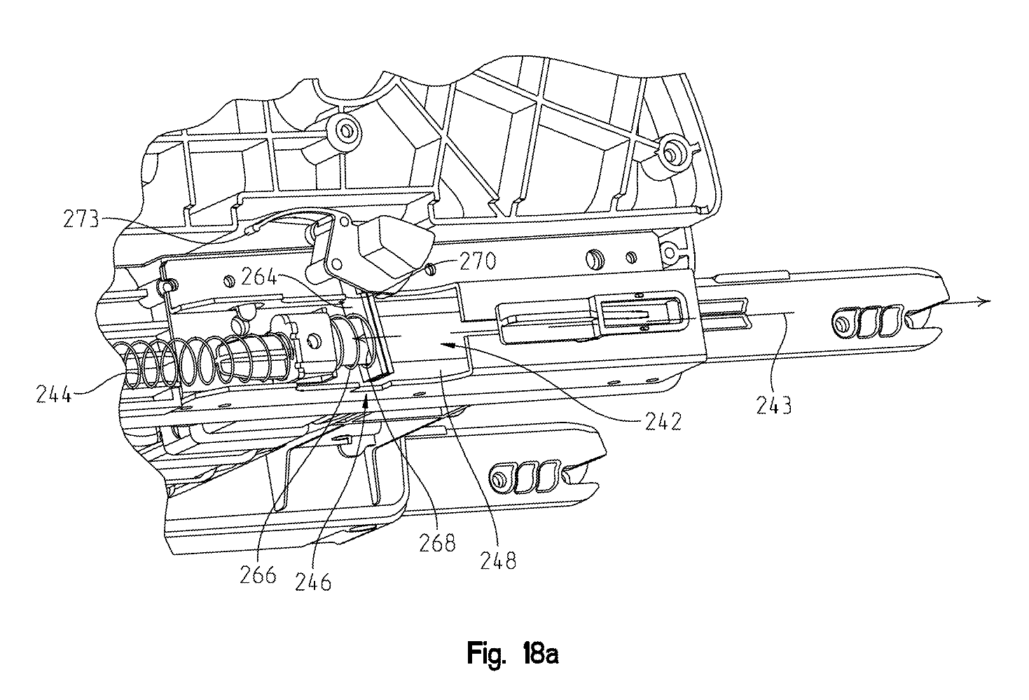

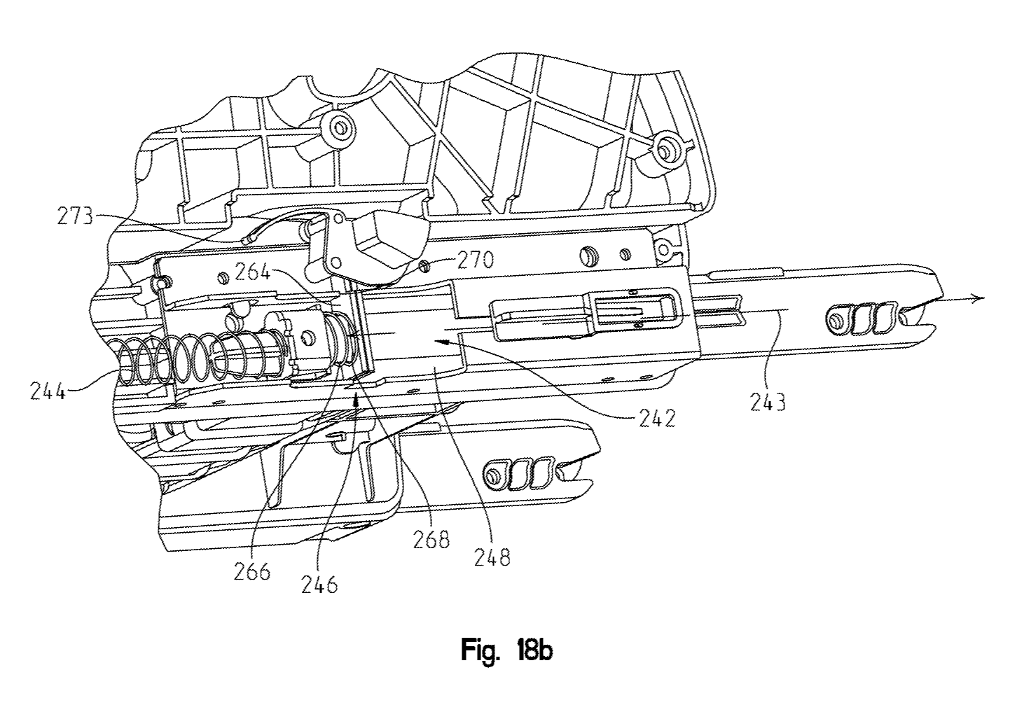

Outward locks 246, when engaged (FIG. 18a), prevent movement of rods 242 outwardly under the urging of springs 244 or otherwise. Outward locks 246, when disengaged (FIG. 18b), allow movement of rods 242 outwardly under the urging of springs 244 or otherwise. Each outward lock 246 is constructed from metal plate(s) 264 and lock spring 266. In the illustrated embodiment, metal plate 264 is actually two abutting identically sized plates. Metal plate 264 is sized to have a width that is less than a width of rod pathways 248. Metal plate 264 further includes rod void 268 therein. Rod void 268 is substantially rectangular in cross section and having dimensions that are slightly larger than the outer dimensions of body 250. Metal plate 264 is further sized to extend through lock aperture 270 defined in rod pathways 248. Metal plate 264 acts as a lever that uses the point at which it extends through lock aperture 270 as a fulcrum. Metal plate 264 is thus able to rotate to assume multiple angles relative to rods 242 (and relative to longitudinal axis 243 of rods 242). Lock buttons 271 rotatably engage base 12. Rotation of lock buttons 271 provides for engagement with lock plate 264 to move lock plates 264 between the engaged and disengaged positions.

When metal plate 264 is perpendicular, or nearly perpendicular, to longitudinal axis 243 of rod 242, rod 242 is able to move freely within rod void 268. Absent other forces, when metal plate 264 is perpendicular to longitudinal axis 243 spring 244 are able to urge rods 242 outwardly. Placing metal plate 264 into perpendicular positioning requires compression of lock spring 266. A user's finger, via lock button 271, urges the portion of metal plate 264 extending outside of rod pathways 248 rearward (direction 272) to place metal plate 264 perpendicular to longitudinal axis 243. Absent urging by a user's finger, lock spring 266 is able to urge metal plate 264 to a position away from perpendicular relative to longitudinal axis 243. Furthermore, lock button 271 includes spring arm 273 that urges lock button 271 to a position that does not engage metal plate 264. Accordingly, absent user urging, lock button 271 and metal plates 264 default to the position shown in FIG. 18a.

When lock spring 266 urges metal plate 264 away from perpendicular, the cross section of rod void 268, as seen from the perspective of longitudinal axis 243, has decreased height. Accordingly, upper and lower sides of rod void 268 engage upper and lower sides of rod 242, respectively. Such engagement prevents relative movement therebetween. Thus, because metal plate 264 is prevented from having translational movement along longitudinal axis 243, rod 242 is similarly locked from movement along longitudinal axis 243. Any force that would that would cause rod 242 to extend outwardly also pulls metal plate 264 to further rotate away from perpendicular. Thus, such force causes rod void 268 to exert more locking force on rod 242. Thus, absent a user urging metal plate 264 to the perpendicular position, any force that urges rod 242 outwardly (direction 272) is met with rod 242 being locked in place. However, any force that would that would cause rod 242 to extend inwardly (direction 274) also pushes metal plate 264 to compress lock spring 266 until metal plate 264 is close enough to perpendicular to allow relative movement between metal plate 264 and rod 242. Thus, rod 242 is able to move inward (direction 274) but not outward (direction 272). Accordingly, in use, seat 10 can become more tightly bound to a vehicle, but cannot become less tightly bound unless a user acts on metal plate 264.

In use, rods 242 are extended by a user acting on metal plate 264 and allowing springs 244 to urge rods 242 outwardly (direction 272). Base portion 12 is located such that latch ends 252 are aligned with lower anchorages. Base portion 12 is then pressed rearward (direction 272) to cause latches in latch ends to couple to the lower anchorages. However, it should be appreciated that a force pressing base portion rearward (direction 272) onto lower anchorages also causes the equal and opposite force (direction 274) exerted by the lower anchorages onto rods 242.

As previously discussed, forces in direction 274 exerted on rods 242 can cause movement of metal plate 264 and allow rods 242 to move in direction 274. This can result in the inability to exert enough force on latch ends 252 to achieve latching onto lower anchorages. Thus, users could be required to directly grasp rods 242 to urge them in direction 274. Directly grasping rods 242 can be difficult and cumbersome.

Accordingly, inward locks 247 are provided. As previously noted, bolt head 262 extends on the outer side of rod pathways 248 and travels in unison with rods 242 due to a connection therebetween. Inward locks 247 are formed from a flexible plastic and include release button 276, fulcrums 278, block 280, and spring member 290.

Inward locks 247 are coupled to the exterior of rod pathways 248 and are located substantially within exterior molding 13 of base portion 12. Release button 276 includes first surface 292 and second surface 294 perpendicular to first surface 292. When inward lock 247 is coupled to rod pathway 248, first surface 292 is substantially parallel to surface 306 in which slide void 260 is formed. Block 280 is angled such that block end 296 engages surface 306. Release button 276, block 280, and fulcrums 278 are formed to rigidly move together. Spring member 290, however, while formed together with the rest of inward lock 247, is formed to hinge in a spring-like manner relative to the balance of inward lock 247. In assembly, outer surface 298 of spring member 290 engages an inner surface of exterior molding 13 of base portion 12.

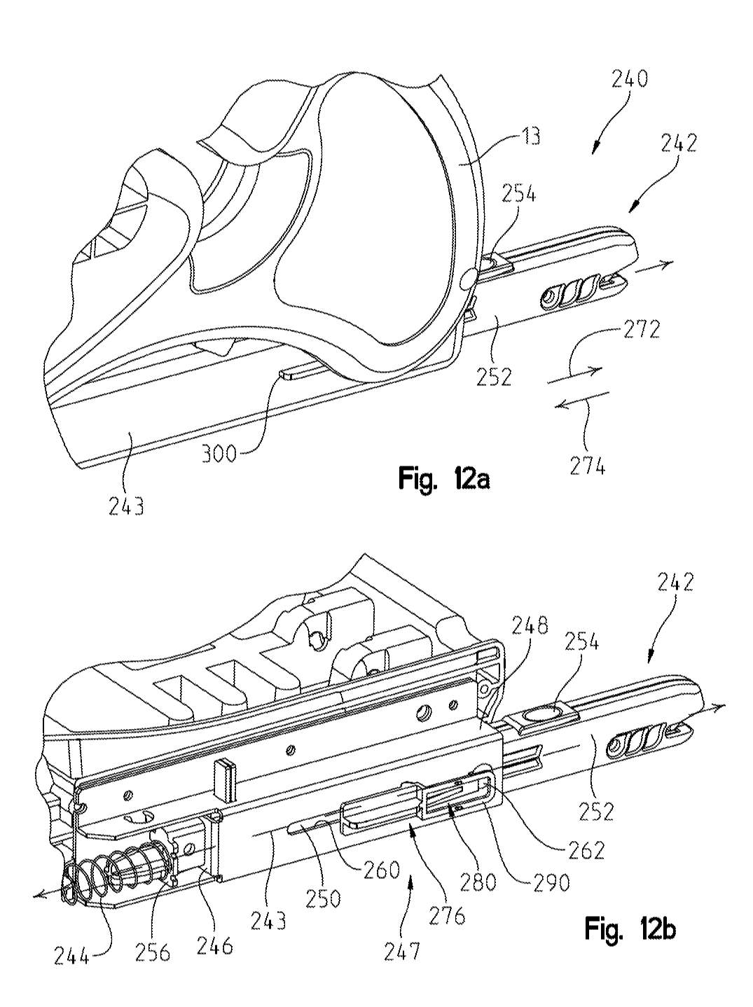

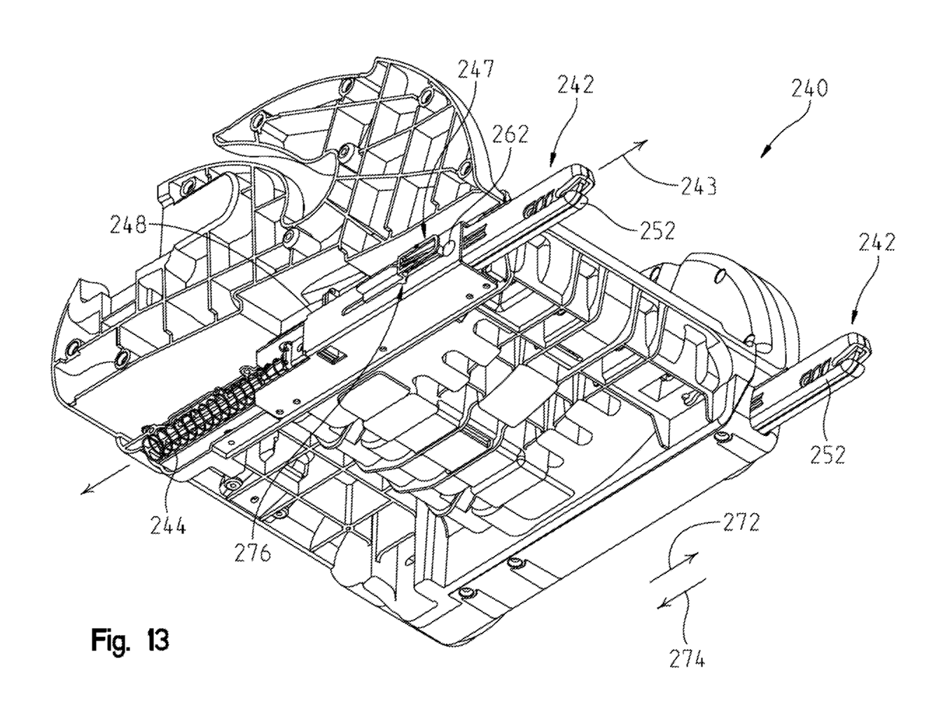

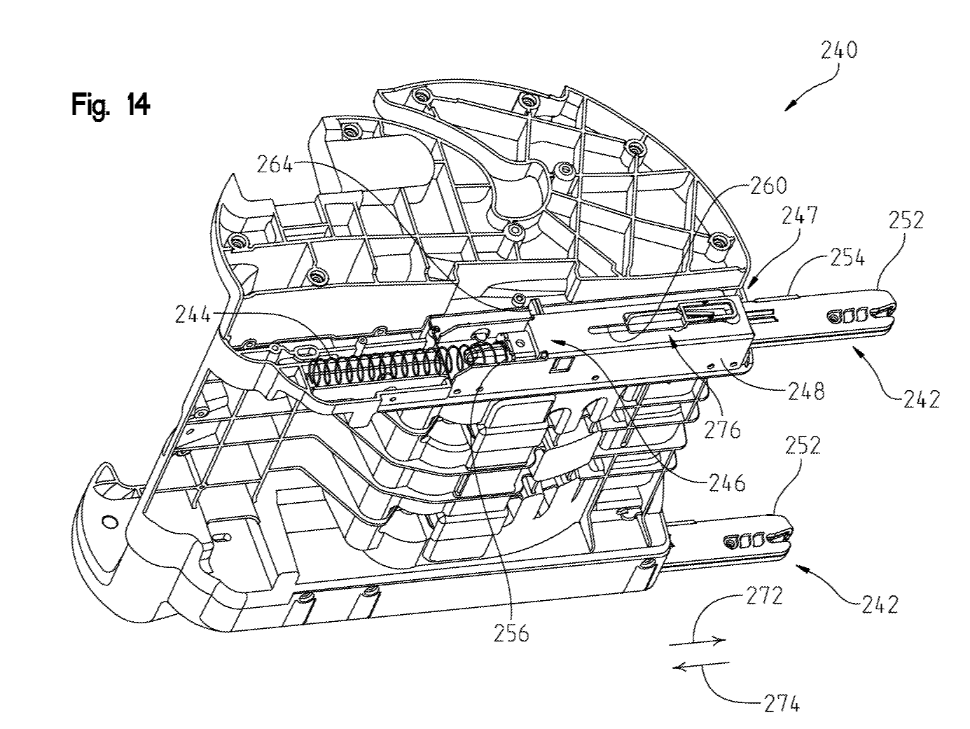

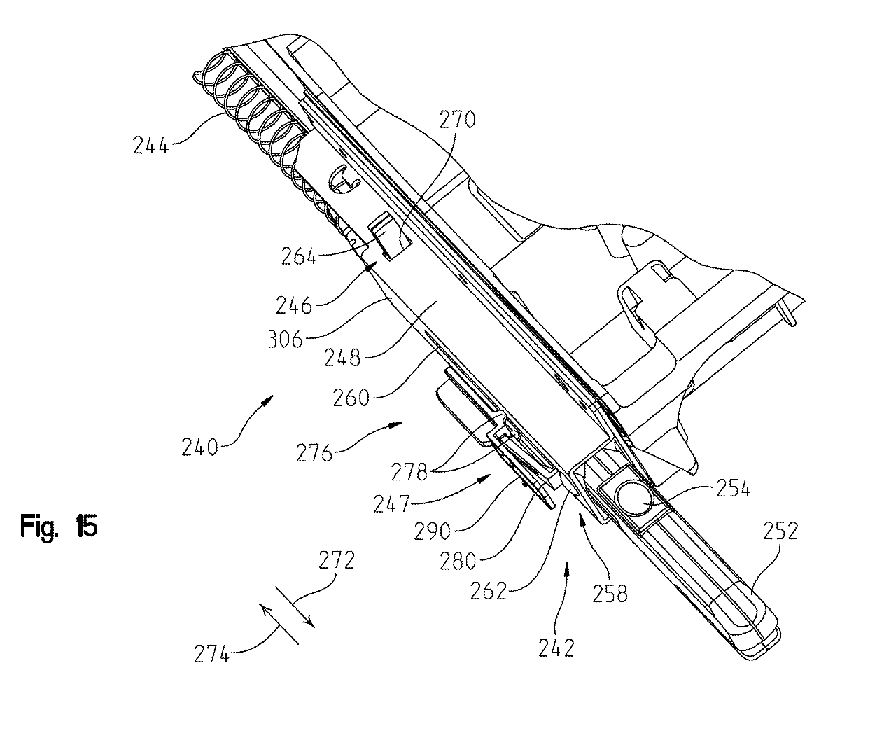

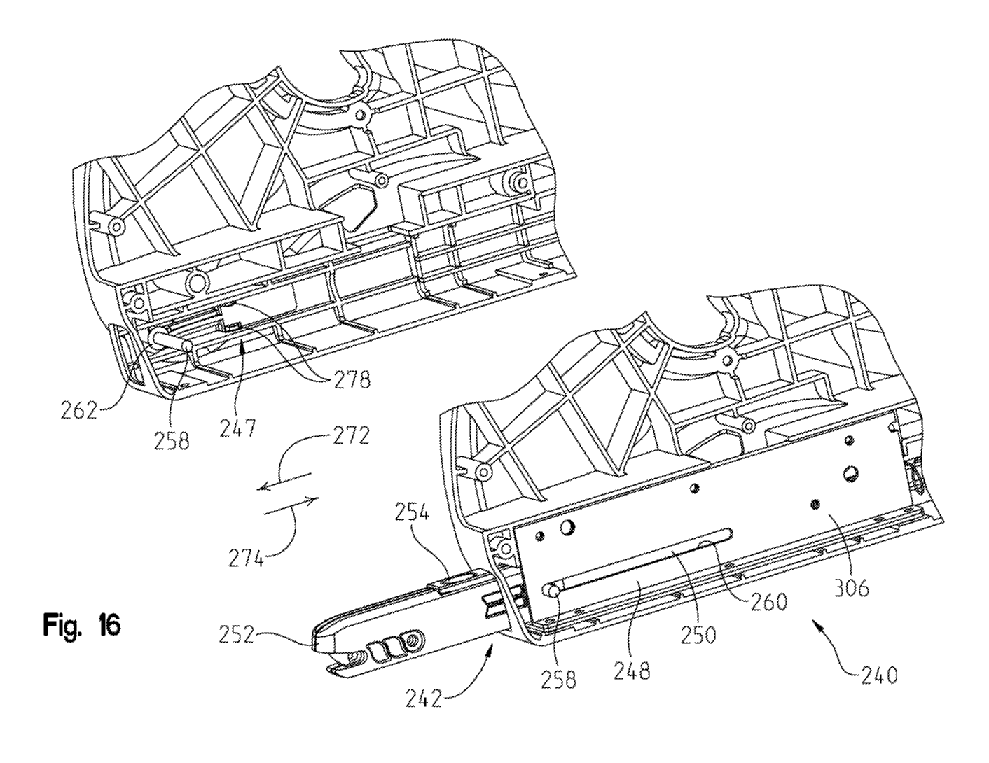

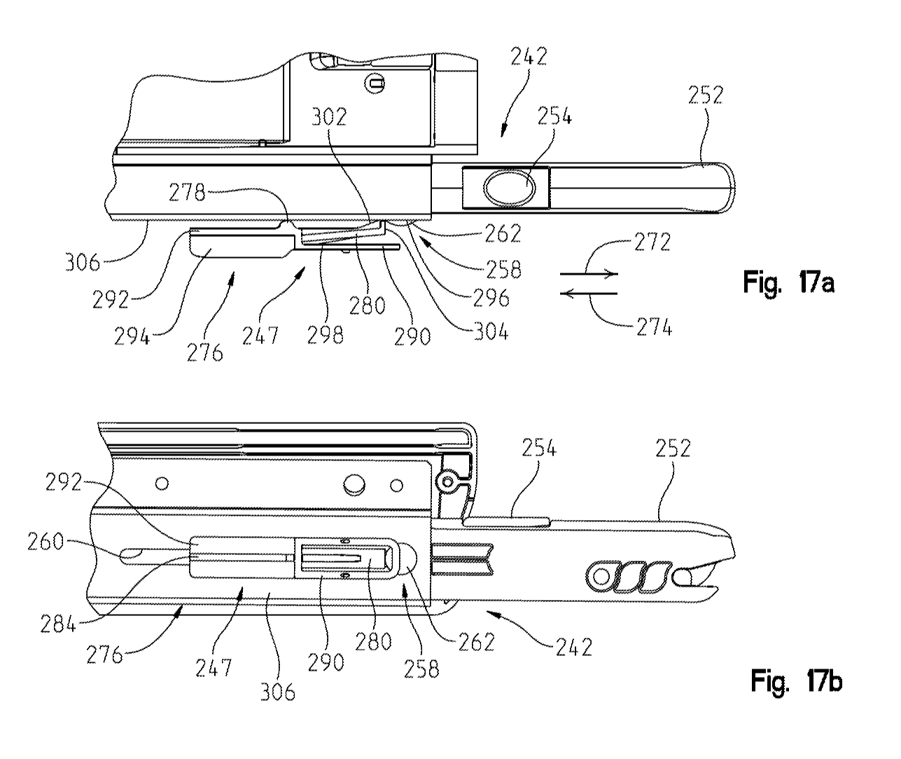

Accordingly, in a rest position, spring member 290 engages an inner surface of exterior molding 13. The size and relative offset of spring member 290 to block 280 causes block end 296 to abut surface 306. The rigid nature of inward locks 247 also proscribes that spring member 290 causes second surface 294 of release button 276 extend out of inward lock aperture 300 defined in exterior molding 13 (See FIG. 12a).

A user presses on the portion of second surface 294 extending out of inward lock aperture 300 to cause inward lock 247 to rotate about fulcrums 278. Such rotation causes block end 296 to rotate away from abutment with surface 306. Once a user stops pressing on the portion of second surface 294 extending out of inward lock aperture 300, spring member 290 urges block end 296 to rotate towards abutment with surface 306.

As previously discussed, as rods 242 slide within rod pathways 248, slide bolt 258 slides within slide void 260. Also, bolt head 262 slides along surface 306. So as to not impede such sliding, fulcrums 278 are positioned on opposing sides of slide void 260, giving clearance for bolt head 262 to slide between fulcrums 278, see FIG. 15. As movement of rods 242 nears its terminal position in direction 274, bolt head 262 abuts surface 302 of block end 296. Surface 302 of block end 296 is abutted by bolt head 262 when bolt head 262 moves in direction 274. Surface 302 provides a beveled surface. Accordingly, further movement after such abutment urges inward lock 247 to rotate about fulcrums 278 causing block end 296 to rotate away from abutment with surface 306. Bolt head 262 is thus able to travel “under” and past block end 296. Alternatively, the user can depress second surface 294 to allow bolt head 262 and rod 242 to slide to their terminal positions in direction 274.

Once bolt head 262 and rod 242 are at their terminal positions in direction 274, block end 296 is able to abut surface 306. Any movement or attempted movement of bolt head 262 in direction 272 causes bolt head 262 to abut surface 304 of block end 296. Unlike surface 302 of block end 296 encountered by bolt head 262 when moving in direction 272, surface 304 of block end 296 that is encountered when moving in direction 274 is not beveled. Surface 304 prevents movement of bolt head 262. Bolt head 262 can only move past block end 296 once second surface 294 is depressed to cause block end 296 to rotate out of abutment with surface 306 of rod pathways 248.

Accordingly, in use, a user attempting to secure seat 10 in a car activates outward locks 246 such that springs 244 can urge rods 242 to their terminal positions in direction 274. If necessary, the user also activates inward locks to aid in bolt head 262 passing “under” block end 296 to reach its terminal position in direction 274. Once rods 242 are fully extended, the user releases any of outward and inward locks 246, 247 that were previously being acted upon by the user. Base portion 12 is located such that latch ends 252 are aligned with lower anchorages. Base portion 12 is then pressed rearward (direction 272) to cause latches in latch ends to couple to the lower anchorages. The equal and opposite force (direction 274) exerted by the lower anchorages onto rods 242 are countered by bolt head 262 abutting surface 304 of block end 296. Thus, substantially all force imparted to base portion 12 is translated to rods 242 and latch ends 252. The imparted force thus causes latch ends 252 to couple to lower anchorages. Next the user presses second surfaces 294 to unlock rods 242 from their terminal position. While keeping second surfaces 294 depressed, the user imparts force in direction 272. This force causes rotation of metal plates 264 and compression of lock springs 266 such that rods 242 are able to move in direction 274 relative to base portion 12 which tightens the connection between base portion 12 and the seat in which base portion 12 is mounted.

Removal of base portion 12 from the seat in which is mounted is achieved as follows. First, metal plates 264 of outward locks are pressed in direction 272 to unlock outward locks 246. Base portion 12 is then pulled in direction 274 to cause rods 242 to extend out of base portion 12. Once latch releases 254 are out of base portion 12 and are accessible by the user, the user releases metal plates 264. The user then depresses latch releases 254 which cause latch ends 252 to disengage from lower anchorages.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains and which fall within the limits of the appended claims.

1. A child car seat including:
a base portion;
a back portion readily attachable and detachable from the base portion, the back portion including a support extending therefrom; and
a support mount hingedly coupled to the base portion, the support mount including a seating surface for a child sitting in the base portion, the support mount engaging the support of the back portion to couple the back portion to the base portion.

2. The car seat of claim 1, wherein the back portion, when coupled to the base portion via the support mount is rotatable relative to the base portion such that the seat has an upright position and a collapsed position.

3. The car seat of claim 1, further including a lock coupled to the support of the back portion, the lock engaging a part of the base portion to lock the back portion in an upright position.

4-15. (canceled)

16. The car seat of claim 1, wherein when the back portion is coupled to the base portion, the support mount and back portion rotate together relative to the base portion.

17. The car seat of claim 1, wherein the support mount includes an upper wall, a lower wall, a left side wall, a right side wall, and a front end wall.

18. The car seat of claim 17, wherein the front end wall includes a plurality of apertures.

19. The car seat of claim 18, wherein the apertures are sized to receive connectors therethrough that are sized and shaped to be received in ends of the support of the back portion.

20. The car seat of claim 17, wherein the support mount includes a plurality of ridges extending from the upper wall towards the lower wall in a direction perpendicular to the upper wall.

21. The car seat of claim 1, wherein attachment of the back portion to the support mount includes attachment such that a first portion of the back portion is on a first side of the upper wall and a second portion of the back portion is on a second side of the upper wall.

22. The car seat of claim 1, having a first position wherein the back portion is upright and a second position wherein the back portion is collapsed, a top of the back portion rotating forward to go from the first position to the second position.

23. The car seat of claim 22, wherein the seating surface of the support mount has a first position and a second position associated with the first and second positions of the back portion, respectively, the first position of the seating surface being substantially perpendicular to the second position of the seating surface.

24. The car seat of claim 1, wherein the support includes base beams that are joined together by a cross brace at a distal end thereof

25. A child car seat including:
a base portion; and
a back portion readily attachable and detachable from the base portion, the back portion having a first position where the back portion assumes an upright position relative to the base portion, the back portion having a second position where the back portion assumes a collapsed position relative to the base portion, the back portion being rotated towards a front of the base portion to move the back portion from the first position to the second position.

26. The car seat of claim 25, wherein the base portion includes a support surface, and movement of the back portion from the first position to the second position causes rotation of at least a portion of the support surface.

27. The car seat of claim 25, wherein the first position of the back portion causes the car seat to have a first height, first width, and first depth, the second position of the back portion causes the car seat to have a second height, second width, and second depth; the greatest of the group including the second height, second width, and second depth being less than the greatest of the group including the first height, first width, and first depth.

28. The car seat of claim 25, further including a fulcrum about which the back portion rotates to move from the first position to the second position, further including a lock that secures the back portion in the first position; the fulcrum being forward of the lock.

29. The car seat of claim 25, further including a support mount hingedly coupled to the base portion, the support mount including a seating surface for a child sitting in the base portion, the support mount engaging the support of the back portion to couple the back portion to the base portion.

30. The car seat of claim 29, wherein the support mount includes an upper wall, a lower wall, a left side wall, a right side wall, and a front end wall.

31. The car seat of claim 30, wherein the front end wall includes a plurality of apertures sized to receive connectors therethrough; the connectors sized and shaped to be received in ends of support extensions of the back portion.

32. The car seat of claim 30, wherein the support mount includes a plurality of ridges extending from the upper wall towards the lower wall in a direction perpendicular to the upper wall.
